(19) United States
(12) Patent Application Publication
(10) Pub. No.: US 2015/0369781 A1
(43) Pub. Date: Dec. 24, 2015

(54) MEMS FLOW CONTROL CHIP FOR GAS CHROMATOGRAPHY

(71) Applicant: The Penn State Research Foundation, University Park, PA (US)

(72) Inventors: Siyang ZHENG, University Park, PA (US); Mingda ZHOU, University Park, PA (US); Andrew J. MYRICK, University Park, PA (US)

(21) Appl. No.: 14/733,192

(22) Filed: Jun. 8, 2015

Related U.S. Application Data
(60) Provisional application No. 61/997,641, filed on Jun. 6, 2014.

(51) Int. Cl. G01N 30/46; G01N 30/60; B01D 53/02

(52) U.S. Cl. CPC G01N 30/465; B01D 53/025; G01N 30/466; G01N 30/6039; G01N 30/6043; G01N 30/6095; G01N 2030/025

(57) ABSTRACT

A micro-electro-mechanical system (MEMS) flow control chip that can control the flow of gas and be configured to operate in a gas chromatography system are disclosed. The MEMS flow control chip can include at least one inlet port in the chip, at least one outlet port in the chip, at least one flow channel between the inlet and outlet ports, and at least one pneumatic valve in the chip for controlling a flow of gas through the flow channel and between the inlet port and outlet ports. Advantageously, the MEMS flow control chip can be positioned in an oven of the a gas chromatography system and have a temperature approximately the same as one or more chromatographic columns of the system.

### CROSS-REFERENCE TO RELATED APPLICATIONS

This application claims the benefit of U.S. Provisional Application No. 61/997,641 filed Jun. 6, 2014 the entire disclosure of which is hereby incorporated by reference herein.

### STATEMENT REGARDING FEDERALLY SPONSORED RESEARCH

This invention was made with government support under Contract No. DBI-1353870 awarded by the National Science Foundation. The Government has certain rights in the invention.

### TECHNICAL FIELD

The present disclosure relates to a micro-electro-mechanical system (MEMS) chip that can control the flow of gas and in particular a MEMS flow control chip for gas chromatography.

### BACKGROUND

Gas chromatography (GC) is a versatile technique which can be used to detect and isolate analytes in a wide range of samples. The global market for gas chromatography is predicted to be over $1 billion per year by 2015. A gas chromatograph is typically equipped with a sample injection system, a chromatographic column, and detectors such as a flame ionization detector or a mass spectrometer.

GC can be coupled with a number of other instruments and detectors. For example, GC can be coupled with electroantennography (EAG), which measures the electrical potential between the ends of the antenna of an insect in response to volatile odorants. Due to the high sensitivity of the bio-receptors in the antenna to the corresponding compound, an EAG can have a resolving power to specific compounds, typically orders of magnitude higher than current volatile chemical biosensors. By splitting the GC effluent and passing it simultaneously over both an insect antenna and a conventional GC detector, GC peaks that elicit a response in the insect may be identified. This permits the identification of pheromones, which are secreted volatile organic compounds (VOCs) and used as chemical messengers by insects. As such, GC-EAG can be a useful tool to study insect interactions. However, the performance of GC-EAG as well as the sensitivity to plant VOCs for insect-plant interactions may be compromised by the low signal-to-noise ratio (SNR), which results in part from the small, background-noise-level depolarization of receptors in the antenna evoked by VOCs or other sources. Recent studies have demonstrated that the SNR of GC-EAG can be improved by modulating the analyte that is delivered to the antenna at 8Hz with a mechanical chopper stabilizer.

Comprehensive two-dimensional gas chromatography (GC×GC) improves the resolving power of the gas chromatography. It is accomplished by introducing an additional chromatographic column (secondary column), which often has a stationary phase of different polarity, coupled to the primary column with a modulator. GC×GC can help distinguish functional classes of components. The basic functions of GC modulators are to divert or trap and release effluent. There are two main categories of modulators, which include valve-based modulators and thermal modulators. For valve-based modulators, high working temperature (up to 300 degree centigrade) and fully compatible with GC operation remains a challenge. For high-speed separations in GC or 2D GC, it may be important for the sample injection to have narrow injection peaks and to generate a low level of noise.

However, a continuing need exists to provide modulators that can operate effectively with gas chromatography systems.

### SUMMARY OF THE DISCLOSURE

An advantage of the present disclosure is a MEMS flow control chip that can be used to modulate gas flow in a gas chromatography system. Additional advantages of the present disclosure include comprehensive gas chromatography system including modulators that can be operated at a temperature that is approximately the same as or at a temperature that is greater than that of one or more chromatographic column of the system.

These and other advantages are satisfied, at least in part, by a MEMS flow control chip comprising: a first inlet port in the chip, a first outlet port in the chip, a first flow channel between the first inlet port and the first outlet port in the chip, a first pneumatic valve in the chip for controlling a flow of gas through the first flow channel and between the first inlet port and the first outlet port. Advantageously, the flow channel between the inlet port and outlet ports can have a cross sectional area of from about 1 μm² to about 2.5 mm², e.g. from about 100 μm² to about 1 mm².

In one aspect of the present disclosure, the MEMS flow control chip can comprise: (i) a flow channel chip including the first inlet port, the first outlet port, the first flow channel and a valve seat positioned in the first channel, (ii) an actuator chip including a chamber aligned over the valve seat and (iii) a diaphragm positioned between the chamber of the actuator chip and the valve seat of the flow channel chip, wherein the diaphragm can form a seal against the valve seat to prevent gas from flowing through the first channel and includes a moveable portion that can deform along an axial direction into the chamber to allow fluid communication through the first flow channel and between the first inlet and first outlet ports.

Another aspect of the present disclosure includes a gas chromatography system having a MEMS flow control chip configured to receive effluent from at least one chromatographic column and to direct the effluent, directly or indirectly, to another chromatographic column or a detector of the system. Advantageously, the MEMS flow control chip can be at a temperature that is approximately the same as or greater than that of the at least one chromatographic column. The system can further include a controller for actuating a pneumatic valve in the chip. Such a control can actuate (opened and closed) the pneumatic valve at a frequency of about 0.001 Hz to about 1 kHz, e.g. from about 1 Hz to about 1 kHz.

In some embodiments the system include wherein the controller actuates the pneumatic valve during a predetermined pulse and thereby provides a chopped analyte. In other embodiments, the system includes a second chromatographic column. In such an embodiment, the MEMS flow control chip can directs effluent received from the first chromatographic column to the second chromatographic column. In still further embodiments, the system is configured where the MEMS flow control chip is positioned in an oven of the system and can withstand temperatures of between about 20° C. to about 400° C., without substantial loss of stability, reliability or functionality during the period of operating the chip. In other embodiments, the MEMS flow control chip and the one or more chromatographic columns are positioned in an oven of the system.

Another aspect of the present disclosure includes a method of operating a comprehensive gas chromatography system having a primary chromatographic column and N-parallel-secondary chromatographic columns with a chopper modulator therebetween. The method includes introducing carrier gas and effluent from a primary chromatographic column to a chopper modulator (e.g., a MEMS flow control chip); and directing chopped effluent and carrier gas from the chopper modulator independently to any one of the N-parallel-secondary chromatographic columns. Advantageously, the chopper modulator can be operated at a temperature that is approximately the same as or at a temperature that is greater than that of the primary chromatographic column or any one of the N-parallel-secondary chromatographic columns.

Additional advantages of the present invention will become readily apparent to those skilled in this art from the following detailed description, wherein only the preferred embodiment of the invention is shown and described, simply by way of illustration of the best mode contemplated of carrying out the invention. As will be realized, the invention is capable of other and different embodiments, and its several details are capable of modifications in various obvious respects, all without departing from the invention. Accordingly, the drawings and description are to be regarded as illustrative in nature, and not as restrictive.

### BRIEF DESCRIPTION OF THE DRAWINGS

Reference is made to the attached drawings, wherein elements having the same reference numeral designations represent similar elements throughout and wherein:

FIG. 1 is a schematic illustration of a MEMS flow control chip according to an embodiment of the present disclosure.

FIGS. 2A and 2B are diagrams illustrating how a MEMS flow control chip could function in a GC according to an embodiment of the present disclosure.

FIGS. 3A and 3B illustrate a logic control for a MEMS flow control chip according to an embodiment of the present disclosure for chopping of an effluent of a GC column.

FIGS. 4A and 4B are an exploded perspective view of a MEMS flow control chip of the present disclosure with an interface housing that can be used in a GC according to an embodiment of the present disclosure.

FIGS. 5A and 5B are schematic illustrations of GC systems including a MCM according to an embodiment of the present disclosure.

FIGS. 6A and 6B are diagrams illustrating how a MEMS flow control chip could function in a GC according to an embodiment of the present disclosure

FIGS. 7A-7D show characterization of an MEMS flow control chip according to an embodiment of the present disclosure configured in an GC-EAG system.

FIG. 8 is a flow diagram illustrating working principles and switching logic of the valves in the microfluidic flow chip operably connected to a comprehensive gas chromatography having N-parallel-secondary-columns according to an embodiment of the present disclosure.

FIGS. 9A, 9B and 9C are diagrams illustrating working principles and switching logic of the valves in the microfluidic flow chip operably connected to a comprehensive gas chromatography having N-parallel-secondary-columns according to an embodiment of the present disclosure.

### DETAILED DESCRIPTION OF THE DISCLOSURE

The present disclosure relates to a micro-electro-mechanical system (MEMS) chip that can control the flow of gas and in particular a MEMS flow control chip for gas chromatography. The MEMS flow control chip comprises at least one inlet port in the chip, at least one outlet port in the chip, at least one flow channel between the inlet and outlet ports, and at least one pneumatic valve in the chip for controlling a flow of gas through the flow channel and between the inlet port and outlet ports.

Advantageously, the flow channel between the inlet port and outlet ports can have a cross sectional area of from about 1 μm² to about 2.5 mm², e.g. from about 100 μm² to about 1 mm². The MEMS flow control chip of the present disclosure can include additional inlet and outlet ports and flow channels and pneumatic valves. All the flow channels within one chip can all have about the same dimensions and can all have different dimensions. The pneumatics valve within one chip can all have about the same dimensions and can all have different dimensions. The MEMS flow control chip of the present disclosure can also include a sample loop in the chip, which can be used to hold effluent. In certain embodiments, the MEMS flow control chip can tolerate temperatures of between about 20° C. to about 400° C., without substantial loss of stability, reliability or functionality during the period of operating the chip.

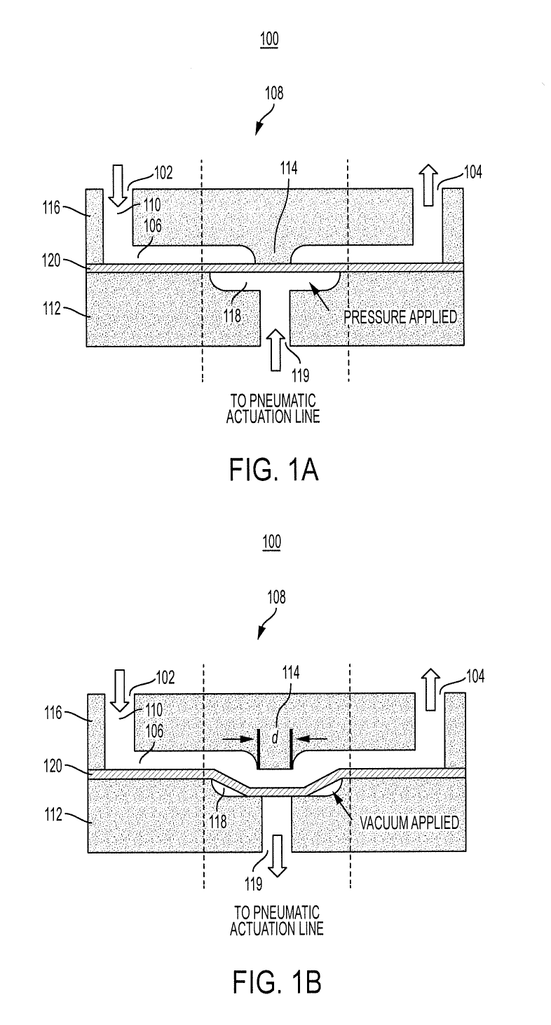

FIGS. 1A and 1B schematically illustrate a MEMS flow control chip according to an embodiment of the present disclosure. As shown in the figures, chip 100 includes inlet port 102, outlet port 104, flow channel 106, and pneumatic valve 108, which controls the flow of gas (110) through flow channel 106 and between inlet port 102 and outlet port 104. The chip can receive effluent from a gas chromatography column and control the discharge of the effluent though the configuration shown in the figures. Pneumatic valve 108 includes flow channel chip 112 having valve seat 114 positioned in flow channel 106. Actuator chip 116 includes chamber 118 therein which is aligned over valve seat 114 and channel 119 to actuate valve 108. Diaphragm 120 is positioned between chamber 118 and valve seat 114. As shown in FIG. 1A, diaphragm 120 can form a seal against valve seat 114 to prevent gas (110) from flowing through channel 106. As shown in FIG. 1B, diaphragm 120 includes a moveable portion that can deform along an axial direction into chamber 118 upon the application of a vacuum through channel 119. When in a closed position, the diaphragm interacts sealingly with a valve seat to block a fluid connection between the first and second ports. The diaphragm can be held with sealing action against the seat by pneumatic pressure and above the valve seat by vacuum. When in an open position, the diaphragm allows fluid communication through the flow channel and between an inlet and outlet port.

The MEMS flow control chip can be constructed by bonding three components together: an actuator chip, a flow channel chip and a flexible diaphragm therebetween. The actuator chip can made of a material that can bond to the diaphragm and flow channel chip and can withstand elevated temperatures, e.g., at least 400° C., and that does not interfere with the operation of a CG. Such materials include, for example, a metal, ceramic, glass, quartz, fused silica, silicon, etc. The flow channel chip should also be made of a material that can withstand elevated temperatures but should also be of a material that can be in contact with the effluent of a GC column and not interfere with the sample. Such materials include, for example, a ceramic, a glass, e.g., a borosilicate glass, quartz, fused silica, silicon, etc. The diaphragm can be composed of a high temperature resistant polymer that is flexible such as a polyimide, e.g., an aromatic polyimide such as poly (4,4′-oxydiphenylene-pyromellitimide) (Kapton).

In an embodiment of the present disclosure the components of the MEMS flow control chip, e.g., the actuator chip, flow chip and diaphragm, can tolerate temperatures of at least 400° C., e.g., between about 20° C. to about 300° C. and between about 80° C. to about 400° C., between about 250° C. to about 400° C., without substantial loss of stability, reliability or functionality during the period of operating the chip. That is, the materials will not substantially degas, or decompose at the operating temperature.

In the embodiment of FIG. 1, the chamber can be about 100 μm deep, with the shape of two 1.6 mm diameter half-circles separated by a square of 1.6 mm by 1.6 mm. A port to access the channel or the chamber can be about 0.8 mm in diameter. In this embodiment, the flow channel in the flow channel chip can be about 250 μm in width and about 100 μin depth and would have a cross sectional area of about 25,000 μm² (0.025 mm²). The valve seat positioned in the flow channel has dimension, d, and can be designed to be within a range of between about 0.1 μm to about 5 mm, e.g., from 500 μm to about 800 μm. Preferably, the dimension of multiple flow channels are approximately the same and the dimension of multiple pneumatic valves are approximately the same. In practice, the actual dimensions of fluidic channels and pneumatic valves tend to be slightly larger than the designed values due to the manufacture of such features when using hydrofluoric acid (HF) etching.

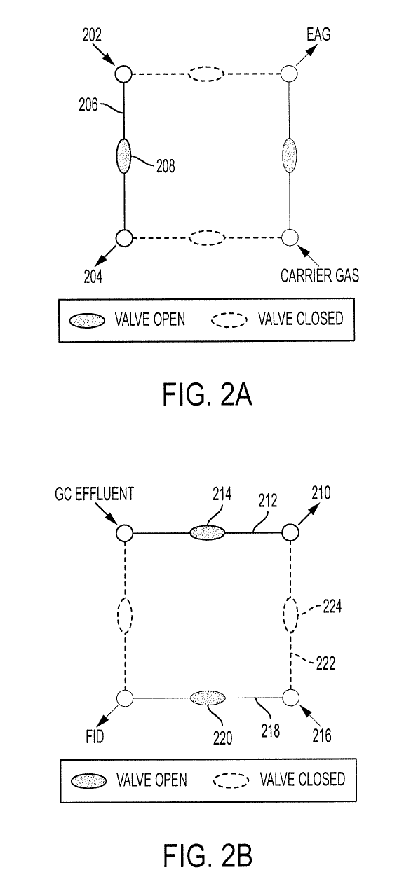

In an embodiment of the present disclosure, MEMS flow control chip can have two inlet ports, two outlet ports, four valves and four flow channels. FIGS. 2A and 2B are diagrams illustrating how such a MEMS flow control chip could function in a GC. As shown in the figures, first inlet port 202 and first outlet port 204 are connected through first flow channel 206. The diagrams further include first pneumatic valve 208 for controlling a flow of gas through the first flow channel and between the first inlet port and the first outlet port. In this embodiment, first inlet port 202 can be used to receive effluent from a GC column and direct the effluent to first outlet port 204 through first flow channel 206 by opening first pneumatic valve 208 (FIG. 2A). Outlet port 204 can be in fluid communication with a detector, e.g., a flame ionization detector (FID).

As further illustrated in these diagrams, first inlet port 202 can be connected to second outlet port 210 through second flow channel 212 by actuation of second pneumatic valve 214. The second pneumatic valve controls the flow of gas through the second flow channel and between the first inlet port and the second outlet port. In this embodiment, effluent received at first inlet port 202 can be directed to second outlet port 210 through second flow channel 212 by opening second pneumatic valve 214 (FIG. 2B). The second outlet port can be fluidly connected to another detector or other component of a GC. In this embodiment, the second outlet port is in fluid communication with an electroantennogram (EAG).

The diagrams further illustrate second inlet port 216, which can receive a carrier gas. Second inlet port 216 is connected to first outlet port 204 through third flow channel 218. The flow of gas between second inlet port 216 and first outlet port 204 is controlled by third pneumatic valve 220. The diagrams further show fourth flow channel 222 between second inlet port 216 and second outlet port 210 and fourth pneumatic valve 224 for controlling the flow of gas through the fourth flow channel and between the second inlet port and the second outlet port.

The diagrams show how a GC-EAG can be operated both without and with a carrier gas. For example, without a carrier gas input, the third pneumatic valve 220 and the fourth pneumatic valve 224 are preferred to be kept closed, and GC effluent can be directed to FID (FIG. 2A) or to EAG (FIG. 2B). With a carrier gas input, GC effluent can be directed to FID and carrier gas is directed to EAG (FIG. 2A) or GC effluent is directed to EAG and the carrier gas is directed to FID (FIG. 2B).

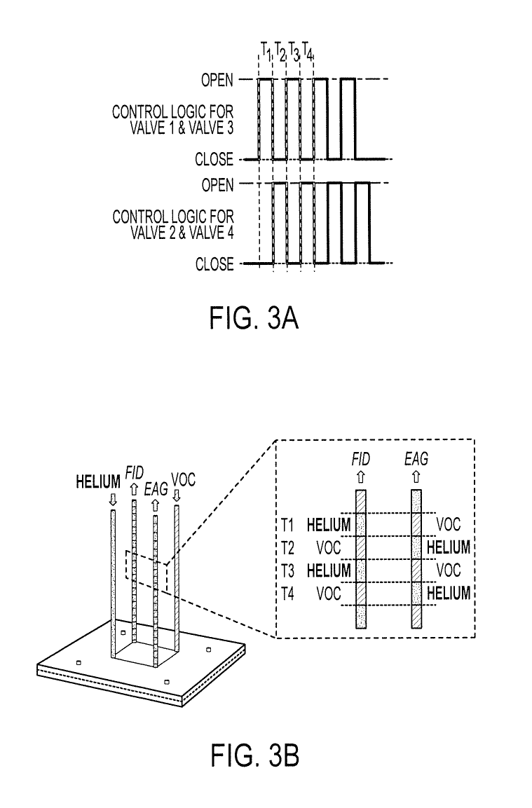

FIGS. 3A and 3B show an example pneumatic control logic for chopping effluent from a GC separation column and directing the effluent or a carrier gas to an FID detector or EAG using a MEMS flow control chip of the present disclosure having four pneumatic valves. FIG. 3B shows a MEMS flow control chip with the flow channel chip facing upward and two inlet ports and two outlet ports. The inlet ports can receive effluent (VOC) from the GC separation column and a carrier gas (e.g., helium), while the outlet ports can be fluidly connected to an FID or EAG. In this embodiment, the MEMS flow chip also includes four pneumatic valves, which are designated clockwise as 1 to 4 in FIG. 3B. The two valves that are on the opposite position share the same control logic, while the control logics for adjacent valves are opposite to each other. By feeding the effluent of the GC separation column and clean helium gas into two diagonal inlets of the MEMS flow control chip and apply the control logic to the valves concertedly, the two outlets on the diagonal will output chopped GC effluents with 180° phase shift.

The four pneumatic valves worked cooperatively with each other and in such a way that the two valves at the opposite position were always at the same open/close status while the two adjacent ones were always at the opposite open/close status. In this way, the VOC effluent from the GC column was directed to FID and EAG alternatively at the frequency dedicated by the valve switching. Thus both FID and EAG received chopped, rather than continuous, VOC signals.

The MEMS flow control chip of the present disclosure can include additional components for connecting the chip to a GC. For example, the MEMS flow control chip can include a housing interface to hold the chip and interface with a controller for actuating (opening and closing) the pneumatic valves and other elements of a GC. The combination of the MEMS flow control chip and interface housing can be referred to as an MEMS chopper modulator (MCM).

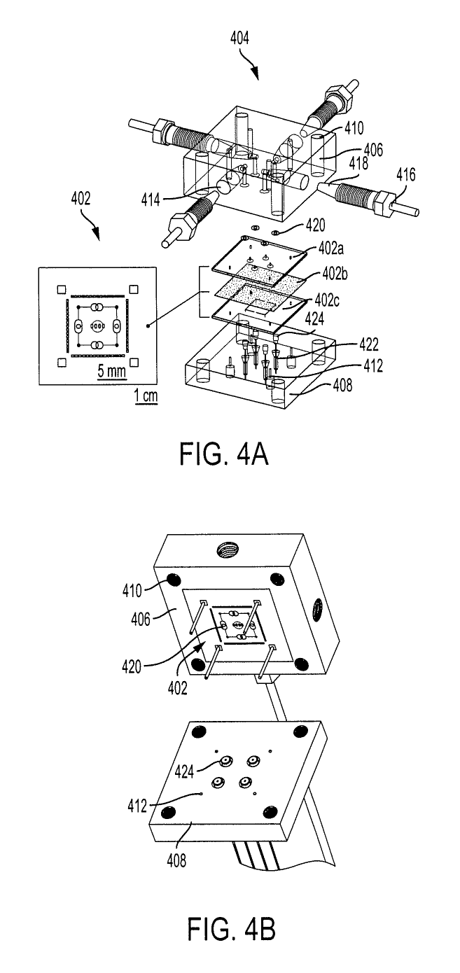

FIG. 4 illustrates exploded perspective view of a MEMS flow control chip of the present disclosure and an interface housing. The housing can provide temperature and pneumatic control as well as a connection interface for the chip. As shown in the figure, MEMS flow control chip 402 is composed of actuator chip 402a, diaphragm 402b, e.g., a polyimide film, and flow channel chip 402c. MEMS flow chip 402 can be fitted in housing 404, which includes top jig 406 and bottom jig 408 that is removeably secured to each other by fasteners through holes 410. The housing can be made of aluminum or other suitable materials, e.g. brass. Aluminum is a preferred material for the housing due to its excellent thermal conductance, easy machining and low cost.

The through holes can be located at the four corners of the top and bottom jigs so that the MEMS flow control chip can be clamped between them with screws or bolts under adjustable pressure using a torque wrench. Alignment holes 412 can also be drilled on each jig so that the MEMS flow control chip can be aligned to the housing with the help of alignment pins. The alignment pins can be removed after assembling the MCM module.

In this embodiment, the top jig of the housing provides connection to pneumatic actuation lines and the bottom jig of the housing interfaces with GC separation columns, clean carrier gas, FID and EAG. As shown in the figure, top jig 404 includes four ports 414 for receiving pneumatic lines 416 sealed to the top jig 406 with graphite ferrules 418. The top jig can be machined to use commercially available fittings (nuts and graphite ferrules, Valco Instruments Co. Inc., Houston Tex.) with high pressure ratings directly. Four high temperature O-rings 420 provided sealing between the top jig and the pneumatic control side (402a) of MEMS flow control chip 402. Pneumatic lines 416 are in fluid communication with chambers in actuator chip 402a for actuating pneumatic valves in MEMS flow control chip 402.

The bottom jig provides fluid connection to inlets and outlets of the flow channel chip 402c through access ports 422. As shown in this embodiment, graphite ferrule 424 can be used to seal a GC column to one of the access ports in bottom jig 408. Such ferrules are available from Chromatography Research Supplies, Louisville Ky., for example.

The interface housing can also be operably connected to a controller for actuating the pneumatic valves of the MEMS flow control chip. Such a control can actuate (opened and closed) the pneumatic valve at a frequency of about 0.001 Hz to about 1 kHz, e.g. from about 1 Hz to about 1 kHz. As shown in FIG. 1B, when the vacuum is applied to a pneumatic valve of the MEMS flow control chip, the diaphragm in the actuation chamber is pulled away from the valve seat. The valve is opened and the gas is allowed to flow freely between the two ports connected by a flow channel. When positive pneumatic pressure (i.e. pressure higher than atmosphere pressure) is applied, the diaphragm is pushed against the valve seat to seal them the flow channel, and the valve is closed. The actuation (opening and closing) of a pneumatic valve in a MEMS flow control chip of the present disclosure can be provided by solenoid mini-valves. For example, the pneumatic actuation for four pneumatic valves can be provided with four high-speed, inexpensive 3-port (two inlets and one outlet) solenoid mini-valves (SMC, Noblesville Ind.) with a total operating power of only about 2 W. The pneumatic control system can reside outside of a GC oven. The two inlets of the solenoid valve can be connected to compressed nitrogen and a vacuum pump, respectively, and the outlet connected to one of the pneumatic chambers of the MEMS flow control device through pneumatic line, e.g. pneumatic line 416 in FIG. 4. Electrical current driving the solenoids can be provided by a Darlington transistor array chip (TI ULN2003A). The timing of the solenoidal valves can be implemented using a computer running conventional software, e.g., LabVIEW, through a conventional data acquisition board (e.g., NI USB-6212, National Instrument, Austin, Tex.). The time resolution can be 1 millisecond or even lower with appropriate hardware.

Advantageously, the MEMS flow control device and interface housing can be sized to readily fit inside a typical GC oven. For example, the MEMS flow control chip can be sized to about 32 mm by 32 mm and the whole MCM module can be sized to be about 50 mm by 50 mm, which made it easily reside inside most of GC ovens. The MEMS flow control device can also be discarded after a certain period of use and replaced with a new chip in the housing.

Further, a thermal control system can be used with the MCM to facilitate the temperature of the MEMS flow control device to match oven temperature when the latter ramps up and compensate heat loss through the pneumatic lines, etc. Such a system can be implemented, for example, with dual proportional-integral-derivative (PID) control optimized using root-locus methods. Resistive heating units can be mounted on an outer surface of each jig using high temperature thermal epoxy to heat up the module and drive its temperature at or slightly above the oven temperature, for example. Real-time temperature can be measured by thermocouples mounted insider the GC oven and on the inner surfaces of both the top and bottom parts of the housing, for example. The temperature information from each thermocouple can be read out and processed using conventional software, e.g., a LabVIEW program (National Instruments, Austin Tex.), which can also provide control signals to the heating units.

In an experiment, we tested the compliance of temperatures on the module as described in FIG. 4 to that of a GC oven. Temperatures on both parts of the housing were measured and compared to the oven temperature when the oven ramped from room temperature to 300° C. at 10° C./sec. At this ramping rate, approximately 30 W power was needed. Without a cooling mechanism, the temperature overshoot was about 2° C. The system was also designed to limit the temperature difference (barely discernible) between the housing top and bottom, which is important to prevent damage to the glass chip.

The MEMS flow control chip of the present disclosure as well as its interface housing can be used in a variety of gas chromatography systems. Another aspect of the present disclosure includes a gas chromatography system including a MEMS flow control chip of the present disclosure configured to receive effluent from at least one chromatographic column and at a temperature that is approximately the same as that of the column and direct the effluent, directly or indirectly, to another chromatographic column or a detector of the system. As explained above, the MEMS flow control chip of the present disclosure can be interfaced with a housing that can fit into an oven of a GC along with one or more chromatographic columns. The gas chromatography system can further include a controller for actuating the pneumatic valve in the chip and another controller for regulating the temperature of the chip. The controller can be configured to actuate pneumatic valves during a predetermined pulse and thereby provides a chopped analyte to another column or to a detector. The MEMS flow control chip of the present disclosure can be used with a variety of detectors including, for example, a flame ionization detector, a flame photometric detector, a concentration gradient sensor based on light beam deflection measurement (Schlieren optics), an electrochemical sensor, a mass spectrometer, or a combination thereof.

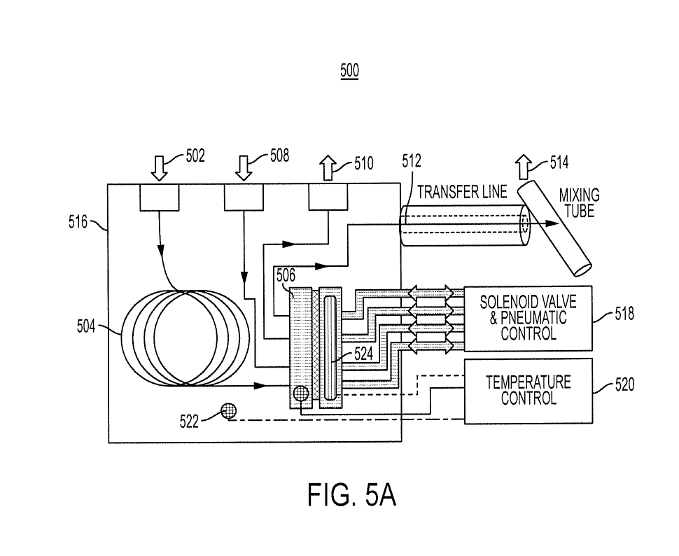

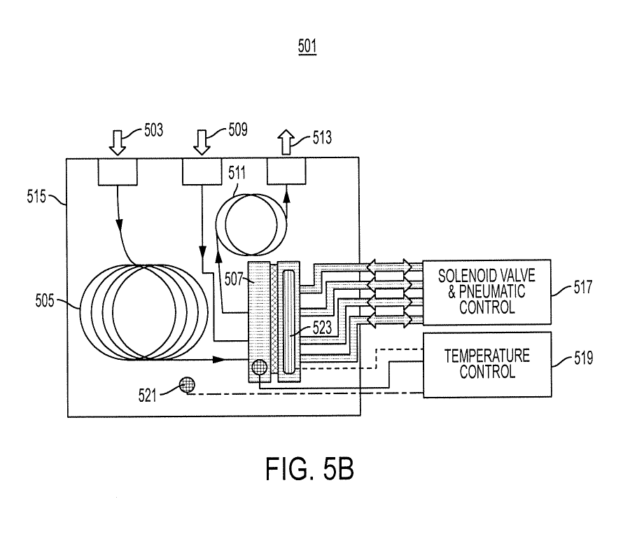

FIGS. 5A and 5B illustrate two different GC systems that include a MCM which includes a MEMS flow control chip of the present disclosure. FIG. 5A illustrates a GC-EAG system. As shown in the figure, GC system 500 includes sample inlet 502, column 504, MCM 506, carrier gas inlet 508, detector 510 and transfer line 512 and EAG 514. As shown in the figure, column 504 and MCM 506 are positioned in oven 516. A MEMS flow control chip (not shown) would be included in MCM 506. The system further includes controller 518 for actuating the pneumatic valves of MEMS flow control chip in MCM 506 and a temperature controller 520 for regulating the temperature of MCM 506 to be approximately the same as the temperature of column 504 by monitoring the oven temperature through thermocouple 522 and regulating heater 524 of MCM 506.

Controller can be configured to operate MCM 506 to actuate pneumatic valves in the MEMS flow control chip for a predetermined period of time to deliver a pulse of analyte, thereby providing a chopped analyte, to detector 510 and EAG 514. FIGS. 3A and 3B show an example pneumatic control logic for chopping effluent from a GC separation column and directing the effluent or a carrier gas to an FID detector or EAG using a MEMS flow control chip of the present disclosure having four pneumatic valves.

FIG. 5B illustrates the implementation of comprehensive two-dimensional gas chromatography (GC×GC), which includes two chromatographic columns, with the MCM. As shown in FIG. 5B, GC system 501 includes sample inlet 503, primary chromatographic column 505, MCM 507, carrier gas inlet 509, secondary chromatographic column 511 and detector 513. As shown in the figure, primary column 505, MCM 507 and secondary column 511 are positioned in oven 515. A MEMS flow control chip (not shown) would be included in MCM 507. The system further includes controller 517 for actuating the pneumatic valves of MEMS flow control chip in MCM 507 and a temperature controller 519 for regulating the temperature of MCM 507 to be approximately the same as the temperature of primary column 505 and secondary column 511 by monitoring the oven temperature through thermocouple 521 and regulating heater 523 of MCM 507.

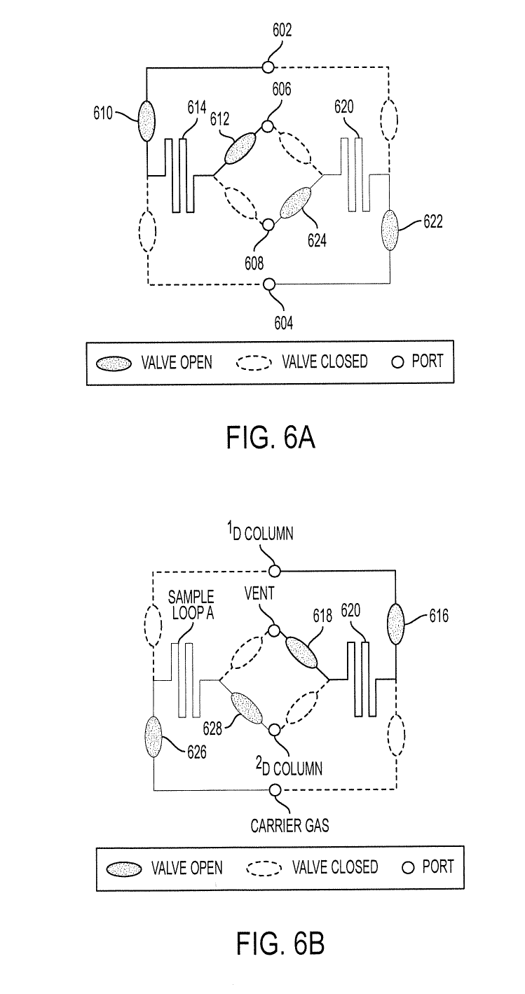

As shown in the figure, injection system 503 in fluid communication with primary chromatographic column 505. Effluent from primary chromatographic column 505 is discharged to MCM, which is fluidily connected to an MEMS flow control chip of the present disclosure, which can then direct effluent to second chromatographic column 511 and detector 513. The controller 517 can be configured to operate MCM 507 to actuate pneumatic valves in the MEMS flow control chip for a predetermined period of time to deliver a pulse of analyte, thereby providing a chopped analyte, to secondary column 511 and detector 513. FIG. 6 shows an example pneumatic control logic for chopping effluent from a primary column to a secondary column.

The GC system shown in FIG. 5B is one of many configurations that be configured to include two chromatographic columns and at least one detector. Other GC systems, including two-dimensional (2D) gas chromatography systems (2D GC) are also contemplated for using the MEMS flow control chip of the present disclosure.

In another embodiment, the MEMS flow control chip can be configured to include eight pneumatic valves, two inlet ports and two outlet ports. Such a configuration can be used in a comprehensive two-dimensional gas chromatography (GC×GC), for example. FIGS. 6A and 6B are diagram illustrating how such a MEMS flow control chip could function in a comprehensive two-dimensional gas chromatography (GC×GC). As shown in the figures, inlet port 602 can be configured to receive effluent from a primary column (¹D column)(not shown), inlet port 604 can be configured to receive a carrier gas and outlet port 606 can be discharged to vent and outlet port 608 can be directed to into secondary column (²D column) (not shown). When pneumatic valves 610 and 612 are open, effluent flows through pneumatic valves 610 and load sample loop A 614 (FIG. 6A). When pneumatic valves 616 and 618 are open, effluent flows through pneumatic valves 616 and load sample loop B 620 (FIG. 6B). When pneumatic valves 622 and 624 are open, carrier gas flows through pneumatic valves 622 and 624 to outlet port 608 thereby directing effluent in sample loop B 620 to into secondary column (²D column) (FIG. 6A). When pneumatic valves 626 and 628 are open, carrier gas flows through pneumatic valves 626 and 628 to outlet port 608 thereby directing effluent in sample loop A 614 to into secondary column (²D column) (FIG. 6B).

In this embodiment, the MEMS flow control chip includes sample loops, e.g., sample loop A and B. However, the on-chip sample loops can be replaced with off-chip sample loops by adding additional ports into the device without additional complexity.

The MEMS flow control chip of the present disclosure can be configured with a comprehensive gas chromatography having a primary chromatographic column and N-parallel-secondary chromatographic columns. Any one of the N-parallel-secondary columns can be the same as or different from another of the N-parallel secondary chromatographic column. A sample loop between the MEMS flow controller and each of the N-parallel columns is optional. Each of the N-parallel secondary columns can be fed into an individual detector (e.g., N individual detectors) and any one of the N detectors can be the same as another or it can be different from another of the N detector.

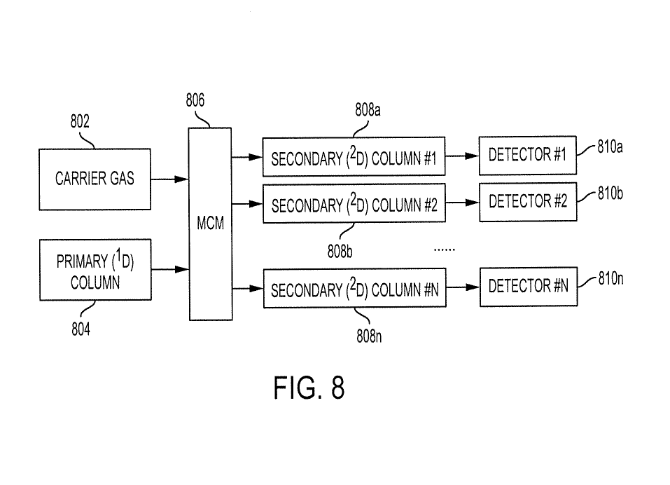

In one aspect of the present disclosure, a MEMS flow control chip of the present disclosure having 2N pneumatic valves (N is an integer, and N>1) is operatively configured with a comprehensive gas chromatography having a primary chromatographic column and N-parallel-secondary chromatographic columns. FIG. 8 illustrates working principles and switching logic of the valves in such a MEMS flow control chip that is operably connected to a comprehensive gas chromatography having N-parallel-secondary-columns.

As shown in FIG. 8, a supply of carrier gas (802) and a primary chromatographic column (804) are fluidly connected to a chopper modulator (806). In one aspect of the present disclosure the chopper modulator, is a MEMS flow control chip chopper modulator (MCM) with 2N pneumatic valves. The chopper modulator (806) is fluidly connected to N-parallel-secondary chromatographic columns (808a-808n) which are fluidly connected to N-detectors (810a-810n).

The process of operating a comprehensive gas chromatography system having a primary chromatographic column and N-parallel-secondary chromatographic columns with a chopper modulator therebetween can include introducing carrier gas and effluent from a primary chromatographic column to a chopper modulator and directing chopped effluent and carrier gas from the chopper modulator independently to any one of the N-parallel-secondary chromatographic columns.

Advantageously, the chopper modulator (e.g., MEMS flow control chip) can be operated at approximately the same temperature or above the temperature of the primary chromatographic column or any one of the N-parallel-secondary chromatographic columns. Preferably the chopper modulator, the primary chromatographic column and the N-parallel-secondary chromatographic columns are operated at approximately the same temperature. In one embodiment, the primary chromatographic column and the N-parallel-secondary chromatographic columns are operated in an oven of the system.

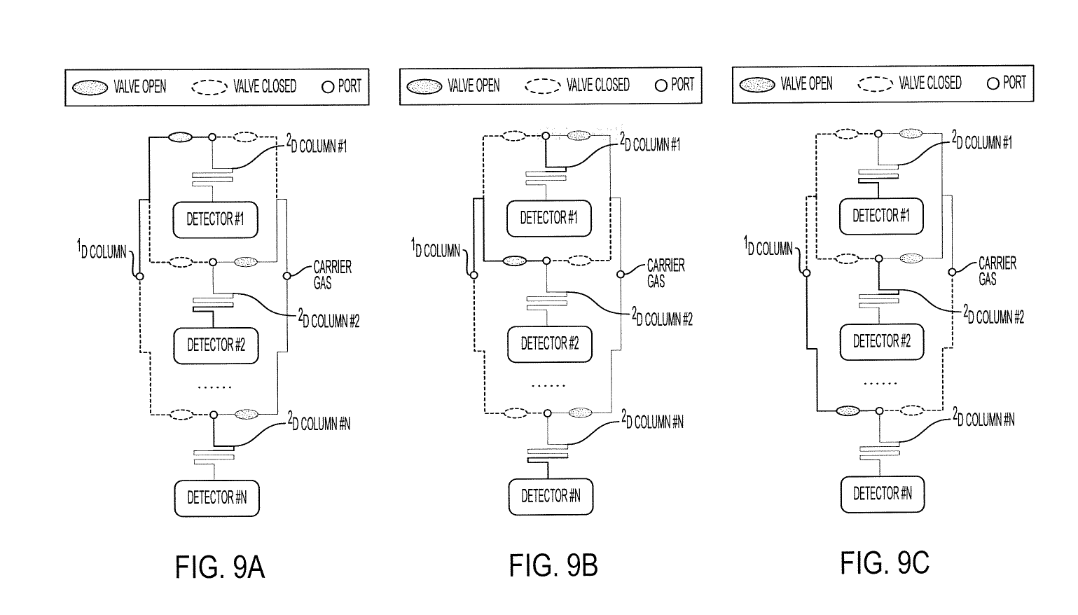

FIGS. 9A, 9B and 9C illustrate an operation algorithm for a comprehensive gas chromatography system having a primary chromatographic column and N-parallel-secondary chromatographic columns and with a MEMS flow control chip of the present disclosure having 2N pneumatic valves. For example, at time T₁, the effluent from primary column is fed into secondary column #1 through the sample loop #1, which is optional, and carrier gas is fed into the other secondary columns (FIG. 9A). At time T₂, the effluent from primary column is fed into secondary column #2 through the sample loop #2, which is optional, and carrier gas is fed into the other secondary columns (FIG. 9B). At time T_{N}, the effluent from primary column is fed into secondary column #N through the sample loop #N, which is optional, and carrier gas is fed into the rest of the secondary columns (FIG. 9C). At time T_{N+1}, the process repeats, e.g., the effluent from primary column is fed into secondary column #1 through the sample loop #1, which is optional, and carrier gas is fed into the rest of the secondary columns (FIG. 9A).

As shown in FIGS. 9A-9C, a comprehensive gas chromatography system having a primary chromatographic column and N-parallel-secondary chromatographic columns can be operated by loading one of the N parallel secondary columns with the effluent from primary column while flushing the other N-parallel secondary columns with carrier gas (auxiliary carrier gas) that is supplied independent of primary column. The system can be operated by a first-loaded-first-flushed algorithm, i.e., the secondary column that is first loaded with effluent from the primary column is first to be flushed with auxiliary carrier gas.

### EXAMPLES

The following examples are intended to further illustrate certain preferred embodiments of the invention and are not limiting in nature. Those skilled in the art will recognize, or be able to ascertain, using no more than routine experimentation, numerous equivalents to the specific substances and procedures described herein.

Fabrication of MEMS Flow Control Chip

Flow channel chips and pneumatic actuation chips were fabricated using commercial 1.1 -mm-thick borosilicate photomask blanks (Telic company, Valencia Calif.) with pre-coated 120 -nm-thick chrome and 530 -nm-thick AZ1518 photoresist. The GC flow channel chip and pneumatic actuation chip were defined by lithography on separate glass blanks with contact aligner (Karl Suss MA/BA6), developed with 20% Microposit™ 351 developer (Rohm and Haas Electronic Materials, Marlborough, Mass.) and then etched in chrome etchant (CR-7, KMG Chemicals Corporate, Houston, Tex.) to generate the chrome masks for HF etching. Then they were etched in 49 wt % HF to form 100 μm-deep structures with the backside of substrate protected with self adhesive vinyl sheet. The substrate was then diced into individual chips. A piece of blank backing glass was temporarily bonded to the backside of the glass chip on a hot plate with Crystalbond™ (Electron Microscopy Sciences, Hatfield Pa.). Gas access ports and alignment holes for chip assembly were precisely drilled on each glass chip by a CNC machine with a 0.76 mm diameter diamond drill bit. Any glass debris was removed by ultrasonicating the substrate in 1% Micro-90 solution (Sigma-Aldrich). The backing glass was released by dissolving the Crystalbond™ with acetone and then the chip was rinsed with IPA and deionized (DI) water. The photoresist and chrome film on the glass chip was then removed.

To start the bonding process, the polyimide film (50 μm-thick, DuPont Kapton HN®) was cut into the appropriate size. The thickness of the film was relatively thin to increase the valve operation speed. Pure polymer film without any coating was selected for the requirements of high temperature and low gas adsorption during operation. The microfluidic channel chip, polyimide film and pneumatic actuation chip were aligned together with a custom-made bonding jig using the alignment holes and pins. The assembly jig was designed to provide uniformly distributed and controlled pressure to the MEMS flow control chip with four corner screws (thread size: 10-32) tightened to 0.68 N·m by a torque wrench. Polyimide film is difficult to form strong bonds with other materials. (See Bayrashev, et al. The Fifteenth IEEE International Conference on Micro Electro Mechanical Systems, 2002, pp. 419-422; Metz, et al., 2001. Polyimide-based microfluidic devices. Lab Chip 1(1), 29-34; Wohl, et al. 2009 Modification of the surface properties of polyimide films using polyhedral oligomeric silsesquioxane deposition and oxygen plasma exposure. Appl Surf Sci 255(18), 8135-8144). To improve the bonding strength, the glass chips were activated with piranha solution (95% H₂SO₄: 30% H₂O₂=3:1) and baked at 115° C. for 5 minutes on a hot plate Grover, et al., Teflon films for chemically-inert microfluidic valves and pumps. Lab Chip 2008: 8(6), 913-918. The polyimide film was cleaned by ultrasonication in acetone, IPA and DI water, and baked in a vacuum oven at 120° C. for 2 hours after blow-dry. The surface of the glass chips and that of the polyimide film were further activated together with oxygen plasma (200 mTorr O₂, 100 W, 10 minutes). The MEMS flow control chip was assembled with the custom-made bonding jig and the whole assembly was annealed at elevated temperature of 450° C. inside an oven filled with inert gas (e.g., N₂) for two hours and then afterwards allowed to cool down naturally. Excellent bonding strength and repeatability were achieved.

Characterization of the Leaking Rate and Switching Speed of an Exemplary MCM

The leak rate of the diaphragm valve in the MEMS flow control chip was characterized at room temperature. One fluidic access port (inlet) of the MEMS flow control chip was connected to the injector of an HP5890 GC system, which provided helium gas flow under controlled pressure, through a piece of 0.32 mm inner diameter (ID) capillary column of 40 cm in length. One of the two fluidic access ports that were adjacent to the inlet was fed into the inlet of a glass vial filled with DI water through a piece of 20 cm long, 0.32 mm ID GC column. The vial was held upside down and any helium gas leaked through the valve would displace water of the same volume, which would vent through the outlet of in the vial.

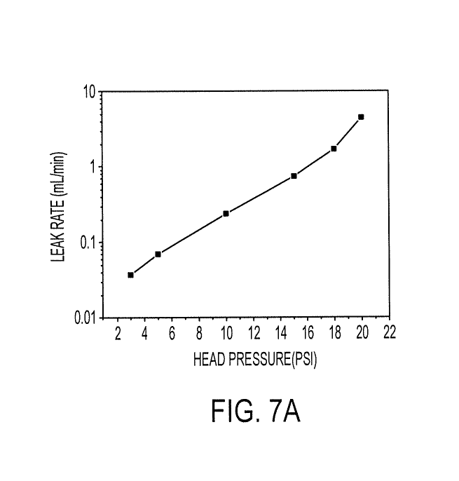

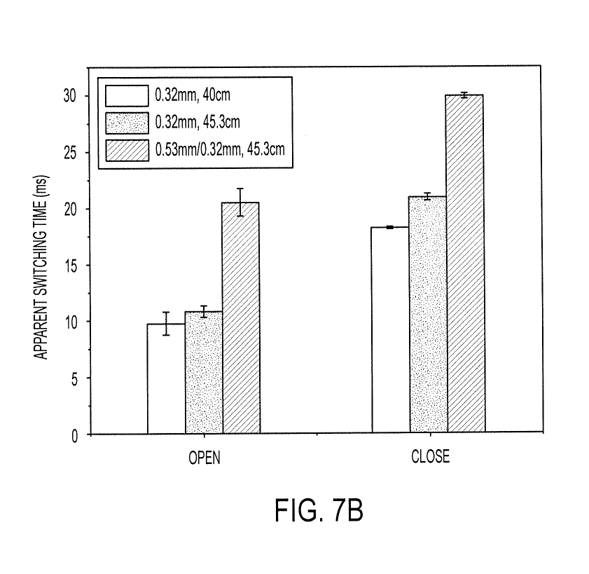

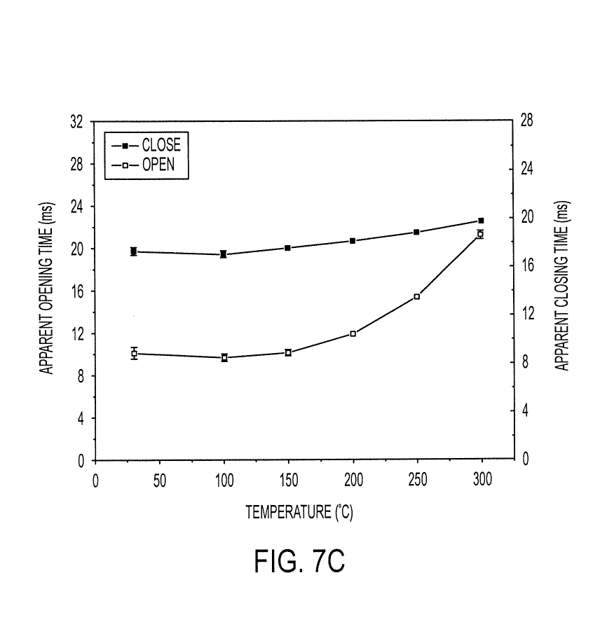

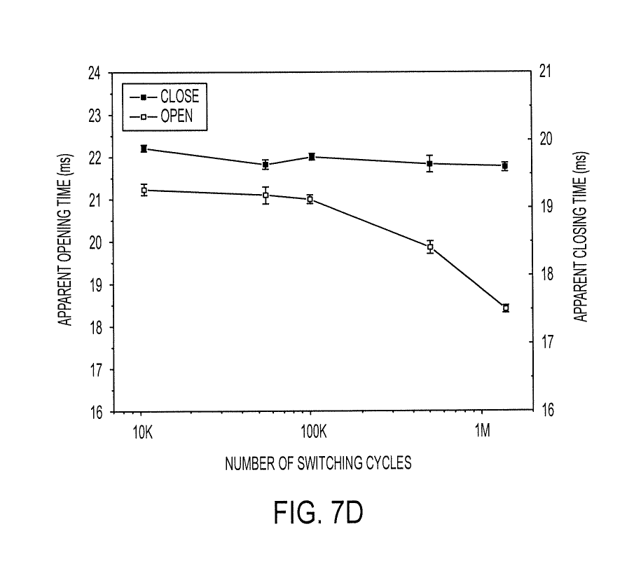

All the four valves within the MEMS flow control chip were shut with 25 pound per square inch (PSI) pneumatic actuation pressure and remain closed during the test. The volumetric leak rate of the valve was calculated with the following formula

$${Q}_{L} = \frac{{W}_{P} - {W}_{A}}{ρ \cdot t} ,$$

where Q_{L} is the volumetric leak rate, W_{P} is the total weight of the glass vial prior to test, W_{A} is the total weight of the vial after the test, ρ is the density of the water, and t is the duration of the test. The relationship between the leak rate and the inlet pressure was investigated with the same system by increasing the head pressure from 3 PSI to 20 PSI (FIG. 7A). The open valve flow rate was measured with the same system by keeping one valve open and the rest closed. At 5 PSI head pressure, which is the estimated highest inlet pressure for the diaphragm valve, the lowest volumetric leak rate could be measured was 7.6 μL/min, approaching the limit of this testing system; the open valve flow rate was measured at 17.86 mL/min. Thus the on/off flow rate ratio of the valve can be over 10³.

FIGS. 7A-7D show characterization of the MCM. The channel separation, d, of the MEMS flow control devices being used was 500 μm unless otherwise specified. 7A: Leak rate of the pneumatic valve (i.e., microvalve) at different inlet pressure when the microvalve was closed by 25 PSI pneumatic actuation pressure (d=800 μm). 7B: Effect of the connective GC capillary column on apparent switching time at room temperature (n=6). Three different configurations were tested: 1) 40 cm long, 0.32 mm ID column; 2) 45.3 cm long, 0.32 mm ID column; 3) 22.6 cm long 0.53 mm ID column plus 22.7 cm long 0.32 mm ID column. 7C: Apparent switching time of the microvalve at different temperatures up to 300° C. (n=6). 7D: Reliability test up to 1 million cycles at 300° C. (n=6). The wave form of chopped hexane at room temperature and at 300° C. before and after reliability testing were approximately the same.

The switching speed of the MEMS flow control device was measured by chopping the hexane effluent at 8 Hz with a duty cycle of 50%. Hexane is a commonly used solvent in GC. The MCM module was installed into the oven of a HP5890 GC system. A 30 m-long 0.32 mm ID GC separation column (DB-5, Agilent; Santa Clara Calif.) was installed into the same oven with its inlet connected to the injector and outlet connected to one fluidic access port (inlet) of the MEMS flow control chip. One of the two fluidic access ports (outlet) adjacent to the inlet was connected to the FID of the GC system with a piece of 40 cm long, 0.32 mm ID GC capillary column. The rest of the fluidic access ports were exposed to the atmosphere. The temperature of the injector and the FID of the GC system were both set at 250° C. The head pressure of the GC separation column was set at 15 PSI. The positive pneumatic actuation pressure was provided by compressed nitrogen regulated at 25 PSI and the vacuum was provided with a continuously working vacuum pump. 1 μL hexane (J. T. Baker, Avantor Performance Materials; Center Valley, Pa.) was loaded into the 30 m-long GC separation column through the injector of the GC system in splitless mode. The four pneumatic valves (i.e., microvalves) within the MEMS flow control chip followed the control logic generated by the LabVIEW program and turned on and off cooperatively with each other in such a way that the two microvalves adjacent to the inlet were always on the opposite open/close status while the rest two valves were kept close all the times. As a result, the hexane effluent from the GC separation column was directed to FID and vented to atmosphere in a chopping mode of 62.5 ms interval by the MCM. The signal from the FID was acquired at 1 kHz sampling rate with a different LabVIEW program. The switching speed of the valve was characterized by the apparent opening and apparent closing times (FIG. 7C). The apparent opening time of the valve is defined as the time it takes for the FID signal to rise from 10% of the full amplitude to 90% of the full amplitude, and the apparent closing time is defined as the time for the FID signal to drop from 90% of the full amplitude to 10% of the full amplitude. Our experiment also showed that the length and the ID of the connecting GC capillary column affect the measured switching time. For the columns of the same ID (0.32 mm), the apparent opening time and apparent closing time measured with 40 cm long column were 9.68±0.99 ms (Average±Std.) and 18.17±0.03 ms, respectively; while those measured with 45.3 cm long column were 10.77±0.46 ms and 20.93±0.27 ms, respectively. When keeping the total length (45.3 cm) of the column constant, replacing a 22.6 cm long segment of column with a 0.53 mm ID column resulted in a 20.47±1.18 ms apparent opening time and a 29.83±0.26 ms apparent closing time. This suggested the measured switching time was only partially determined by the true switching time of the pneumatic valves, which should be better than the measured values. The switching speed of the valve at different temperatures was investigated by changing the temperature from room temperature all the way to 300° C., which was the highest temperature that the HP5890 GC system could reach. At room temperature, the apparent opening time and apparent closing time were 10.19±0.47 ms and 17.38±0.35 ms, respectively. As the temperature increased, both remained almost unchanged (the difference in apparent opening time is less than 5% and that in apparent closing time is less than 2%) when the temperature was below 150° C., and both started to increase after that. At 300° C., the apparent opening time and apparent closing time were measured as 21.30±0.30 ms and 19.80±0.04 ms, respectively, which corresponded to 108.9% and 13.9% increase in comparison to those of room temperature, respectively. The increase in the apparent opening time and the apparent closing time was likely due to the increase in the viscosity of the actuation gas at higher temperature. This was inevitable because the actuation gas line inside the oven was unavoidably heated up as the oven temperature ramped up.

Reliability of the MCM. In MCM-GC-EAG, the MEMS flow control chip is required to keep switching for an extended number of cycles at high temperature. The reliability of this MCM plays a key role in determining its capability in real MCM-GC-EAG or other GC applications. The reliability of the MCM at 300° C. was investigated with the same experimental setup described for switching time characterization. Switching was characterized by the apparent opening time and apparent closing time. The oven and MCM temperature was ramped up to 300° C. and held for a sufficient period of time to allow the actual temperature of MEMS flow control chip to reach 300° C. and stabilize. The two microvalves adjacent to the inlet were kept switching continuously at 8 Hz 50% duty circle throughout the reliability test, while the other two were kept closed at all times. The two microvalves that were programmed to switch always worked in opposite open/close status and delivered GC column effluent pulses of the same frequency and duty circle to the FID. At each time point when the switching time of the microvalve needed to be measured, 1 μL hexane was injected into the 30 m-long GC column through the injector of the GC system in splitless mode. The valve was kept switching continuously for more than 53 hours resulting in more than 1 million cycles. The valve remained fully functional at the end of the test and switched even faster, with the apparent opening time and apparent closing time 18.41±0.09 ms and 19.61±0.07 ms, corresponding to 13.2% and 1.3% decrease, respectively. The apparent opening time decreased monotonically with time. The apparent closing times deviated within 1.3% and those measured during the reliability test were all shorter than that measured at the beginning of the test. The overall waveform of chopped hexane acquired at 300° C. at the end of the reliability test looked identical to that acquired at 300° C. at the beginning of the reliability test. In addition, the waveform of chopped hexane at room temperature was recorded prior to the reliability test, and was recorded again at room temperature after the reliability test. The two waveforms were also identical to each other. These indicated that the valve maintained its function during the reliability test and its performance did not get compromised.

Detection of pheromone with MCM-GC-EAG. Pheromones are secreted VOCs by insects and serve as chemical messengers, which play important roles for their communication. Detection of pheromones with MCM-GC-EAG was demonstrated with a modified Agilent 6190N GC system (FIG. 5A), which allowed MCM to reside inside the oven and the delivery of chopped GC effluent from the MCM to the mixing tube outside the oven through a heated transfer line (Syntech, the Netherlands). A 30 m-long 0.32 mm ID DB-1 GC separation column was installed into the GC system with its outlet fed into one fluidic access port of the MEMS flow control device (inlet). The two fluidic access ports that were adjacent to the inlet were fed to the mixing tube of the EAG system, which was horizontally oriented and perpendicular to the transfer line, and the FID, respectively. The last fluidic access port of the MEMS flow control device was vented to atmosphere. Microelectrodes, which connected the antenna to the data acquisition circuit, were prepared by pulling heated glass capillaries, then filled with 0.9% sodium chloride (NaCl) solution to establish the electrical connection between the antenna and the silver-wire electrodes of the IDAC-2 data acquisition system (Syntech, the Netherlands). The antenna preparation was placed 3˜5 mm to the outlet of the mixing tube.

Helium was employed as the carrier gas and the GC system operated under constant flow rate of 7 mL/min. The temperature of the injector and FID of GC system was set at 300° C. and 220° C., respectively. The transfer line was set at 358° C., much higher than the boiling temperature of the pheromone to eliminate its condensation at the outlet of the transfer line. Air, saturated with water vapor, was pumped into the mixing tube at the rate of 1.2 L/min to mix with the effluent delivered by the transfer line in the tube. The mixture was delivered to the antenna. The control for the MCM was the same as that described for switching time test except all the four microvalves were switching in such a way that the adjacent ones were always on the opposite open/close status while the opposite ones were always on the same open/close status.

cis-11-hexadecenal, the major pheromone component of the moth Helicoverpa Virescens (H. Virescens), was dissolved in hexane and diluted to different concentrations. The oven temperature of the GC system initiated at 100° C. After the temperature of MCM reached the oven temperature and stabilized, the antenna was harvested from a male H Virescens moth and mounted on the microelectrodes after trimming off its tip. The pheromone sample was then loaded into the 30 m-long GC separation column through the injector of the GC system in splitless injection mode. Following injection, the oven temperature started to ramp up to 160° C. at the rate of 15° C/min, then further ramped to 200° C. at the rate of 10° C/min. The oven temperature was maintained at 200° C. after that and until the end of the test. For each trial, 1 pheromone sample solution was loaded.

Chopped GC effluent was expected to evoke waveforms of the same frequency on the raw EAG recording. The antenna from H Virescens, however, demonstrated frequency and duty cycle dependent response. When 10 ng pheromone was loaded into the column and chopped at 8 Hz and 50% duty cycle, there was barely any waveform of the same frequency observed on the raw EAG recording. When same amount of pheromone was loaded but was chopped at 4 Hz and 50% duty cycle, the waveform of the chopping frequency was observed and it stood out more apparent when the duty cycle was decreased to 10% while keeping the chopping frequency at 4 Hz. After signal demodulation, the pheromone peak, which had a characteristic retention time of 312 second, was barely visible when the chopping was 8 Hz but became apparent when the chopping frequency was 4 Hz. In addition, 10% duty cycle resulted in stronger signal than 50% duty cycle at 4 Hz, even though the actual amount of the pheromone delivered to the antenna by the former was just one fifth of the later. This differed from the previous report in which best performance for detection limit was achieved at 8 Hz for moth Helicoverpa Zea Myrick and Baker 2012a, b). We hypothesized that this was due to the condensation of pheromone at the tip of the transfer line, which protruded from its heated housing and resides inside the mixing tube. The continuous flow of room temperature air in the mixing tube tended to cool the tip down and pheromone may condense there. The condensed pheromone then evaporated into the mixing tube when MCM actually turned off its delivery of pheromone to the mixing tube. Thus continuous pheromone instead chopped pheromone was delivered to the antenna. At lower frequency and/or lower duty cycle, when the interval was longer, the condensed pheromone could evaporate off, at least partially, from the tip of the transfer line before MCM's subsequent delivery of pheromone to the mixing tube, which resulted in chopped pheromone delivery to the antenna. This was supported by the observation that as the interval between the potential peaks increased, the measured potential returned more completely to its rest state during the intervals. The antenna could fully return to its rest state during the interval when the pheromone effluent was chopped at 2 Hz with 10% duty cycle, which corresponded to 450 milliseconds interval. After demodulation, 2 Hz 10% duty cycle resulted in a higher pheromone peak than 4 Hz 10% duty cycle. However, lowering the chopping frequency, which was required by the demand to increase the interval, resulted in an elevated noise level. Chopping frequency was not further lowered, and 2 Hz 10% duty cycle was determined as the optimal condition. All the following experiment was carried out under this conditioning unless otherwise specified.

The dose response was investigated by loading pheromone solution of same volume but different concentrations to the injector. In general, the absolute amplitude of pheromone peak after demodulation decreased as the dose decreased. However, the absolute amplitude of 1 ng pheromone was lower to that of 100 pg for this particular set of experiments. This can be explained by the variability in antenna sensitivity from preparation to preparation by noticing the same amount of hexane solvent for each trial resulted in peaks of different heights. Several factors, including the age of the moth, the lifetime of the antenna preparation, the coverage of the antenna by the saline solution in the microelectrodes and difference in the distance between the antenna and the opening of the mixing tube, may contribute to this.

In addition to pheromone detection, the MCM-GC-EAG technology was demonstrated with the detection of a generic natural VOC, the GLV (Z3-6 Ac), using antenna harvested from wild black cutworm moths (Agrotis ipsilonis) with a HP5890 GC system. 1 μg GLV could be detected with MCM-GC-EAG chopping at 8 Hz and 50% duty cycle with great certainty, while its signal was hard to be distinguished from the background noise in the conventional GC-EAG.

### CONCLUSION

A MEMS flow control chip was designed, microfabricated, and characterized as part of a high temperature MEMS chopper modulator (MCM). The MCM can regulate gas flow at GC working temperatures (e.g. 300° C. or higher). The MCM is compatible with GC operation and is small enough to be placed inside most conventional GC ovens. In certain embodiments, the MCM included a disposable MEMS flow control chip, an aluminum housing and peripheral parts for temperature control and interface to pneumatic control lines and GC columns. In certain embodiments, the MEMS flow control chip was constructed by bonding two microfabricated glass chips with a polyimide film, which was inert and served as the diaphragm as the four on-chip microvalves. After surface activation, the bonding process was performed at 450° C. with custom designed jigs. The bonding strength was good enough for the MEMS flow control chip to switch at 300° C. reliably for more than 1 million cycles. Under 25 PSI pneumatic actuation pressure and 5 PSI inlet pressure, the on/off ratio of the microvalve in the MEMS flow control chip at room temperature can reach 10³.

With an MCM made with a MEMS flow control chip of the present disclosure, the unique MCM-GC-EAG technology chopped the GC effluent before it was delivered to the mixing tube. The implementation significantly reduced the noise that arose from the mechanical disturbance of the previously reported chopper. Utilizing the high sensitivity of the sensory neurons of male H Virescens moth to its pheromone cis-11-hexadecenal, the MCM-GC-EAG readily detected pheromone cis-11-hexadecenal at 1 pg level. A lower detection limit is expected if the condensation of pheromone at the tip of the transfer line can be eliminated.

Although the MCM described in an embodiment of the present disclosure was developed for a MCM-GC-EAG, the MEMS flow chip and MCM can be used in many other GC applications. For example, chopping is a general method that can improve SNR of GC detectors. Most GC detectors have predominant noise sources in low frequency and modulation of the sample flow will not modulate inherent detector noise. Thus the signal can be modulated to a higher frequency and recovered by demodulation at the detector without being compromised by low frequency noise sources. This principle has been demonstrated with flame ionization detector (FID), thermal conductivity detector (TCD), electron capture detector (ECD), flame photometric detector (FPD) (Wells 1985), electrochemical sensor, and concentration gradient sensor based on light beam deflection measurement (Schlieren optics). However, all these were limited with the flow control devices that had to reside outside the GC oven, chopping flow at the inlet or outlet. Most methods only improved SNR by one order of magnitude or less. Due to its high temperature operation, small dead volume and miniature size, the MCM reported here can be used to improve the SNR of the GC detectors significantly, although the ultimate performance will depend on the mechanism of the individual detector and its noise sources.

Only the preferred embodiment of the present invention and examples of its versatility are shown and described in the present disclosure. It is to be understood that the present invention is capable of use in various other combinations and environments and is capable of changes or modifications within the scope of the inventive concept as expressed herein. Thus, for example, those skilled in the art will recognize, or be able to ascertain, using no more than routine experimentation, numerous equivalents to the specific substances, procedures and arrangements described herein. Such equivalents are considered to be within the scope of this invention, and are covered by the following claims.

What is claimed is:

1. A MEMS flow control chip comprising: a first inlet port in the chip, a first outlet port in the chip, a first flow channel between the first inlet port and the first outlet port in the chip, a first pneumatic valve in the chip for controlling a flow of gas through the first flow channel and between the first inlet port and the first outlet port, wherein the flow channel has a cross sectional area of between about 1 μm² and 2.5 mm².

2. The MEMS flow control chip of claim 1, comprising: (i) a flow channel chip including the first inlet port, the first outlet port, the first flow channel and a valve seat positioned in the first channel, (ii) an actuator chip including a chamber aligned over the valve seat and (iii) a diaphragm positioned between the chamber of the actuator chip and the valve seat of the flow channel chip, wherein the diaphragm can form a seal against the valve seat to prevent gas from flowing through the first channel and includes a moveable portion that can deform along an axial direction into the chamber to allow fluid communication through the first flow channel and between the first inlet and first outlet ports.

3. The MEMS flow control chip of claim 2, wherein the flow channel chip is composed of a glass and the diaphragm is composed of a polyimide.

4. The MEMS flow control chip of claim 1, further comprising: a second outlet port in the chip, a second flow channel between the first inlet port and the second outlet port in the chip and a second pneumatic valve in the chip for controlling the flow of gas through the second flow channel and between the first inlet port and the second outlet port.

5. The MEMS flow control chip of claim 4, further comprising: a second inlet port in the chip, a third flow channel between the second inlet port and the first outlet port in the chip, a third pneumatic valve in the chip for controlling the flow of gas through the third flow channel and between the second inlet port and the first outlet port, a fourth flow channel between the second inlet port in the chip and the second outlet port in the chip, and a fourth pneumatic valve in the chip for controlling the flow of gas through the fourth flow channel and between the second inlet port and the second outlet port.

6. The MEMS flow control chip of claim 1, wherein the first pneumatic valve can be actuated at a frequency of about 0.001 Hz to about 1 kHz

7. The MEMS flow control chip of claim 1, further comprising at least one sample loop in the chip for holding a quantity of an effluent.

8. The MEMS flow control chip of claim 1, wherein the chip can tolerate temperatures of between about 20° C. to about 400° C., without substantial loss of stability, reliability or functionality during the period of operating the chip.

9. A gas chromatography system comprising the MEMS flow control chip of claim 1 configured to receive effluent from at least one chromatographic column at a temperature that is approximately the same as or greater than that of the at least one chromatographic column and to direct the effluent, directly or indirectly, to another chromatographic column or a detector of the system.

10. The gas chromatography system of claim 9, further comprising a controller for actuating the pneumatic valve in the chip.

11. The gas chromatography system of claim 10, wherein the controller actuates the pneumatic valve during a predetermined pulse and thereby provides a chopped analyte.

12. The gas chromatography system of claim 9, further comprising a second chromatographic column and wherein the MEMS flow control chip directs effluent received from the at least one chromatographic column to the second chromatographic column.

13. The gas chromatography system of claim 9, wherein the MEMS flow control chip is positioned in an oven of the system and can withstand temperatures of between about 20° C. to about 400° C., without substantial loss of stability, reliability or functionality during the period of operating the chip.

14. The gas chromatography system of claim 9, wherein the MEMS flow control chip and the at least one chromatographic column are both positioned in an oven of the system.

15. The gas chromatography system of claim 9, wherein the MEMS flow control chip is configured with eight pneumatic valves.

16. A method of operating a comprehensive gas chromatography system having a primary chromatographic column and N-parallel-secondary chromatographic columns with a chopper modulator therebetween, the method comprising
introducing carrier gas and effluent from a primary chromatographic column to a chopper modulator; and
directing chopped effluent and carrier gas from the chopper modulator independently to any one of the N-parallel-secondary chromatographic columns.

17. The method of claim 16, wherein the chopper modulator is operated at a temperature that is approximately the same as or at a temperature that is greater than that of the primary chromatographic column or any one of the N-parallel-secondary chromatographic columns.

18. The method of claim 16, wherein the chopper modulator, the primary chromatographic column and the N-parallel-secondary chromatographic columns are operated at approximately the same temperature.

19. The method of claim 16, wherein the chopper modulator, the primary chromatographic column and the N-parallel-secondary chromatographic columns are operated in an oven of the system.
